(19) United States
(12) Patent Application Publication
(10) Pub. No.: US 2025/0042034 A1
(43) Pub. Date: Feb. 6, 2025

(54) METHOD AND APPARATUS FOR CALIBRATING THERMAL DRIFT OF ROBOT

(71) Applicant: ABB SCHWEIZ AG, Baden (CH)

(72) Inventors: Shuyi Xiao, Shanghai (CN); Jing Ma, Shanghai (CN); Yin Tian, Shanghai (CN)

(21) Appl. No.: 18/924,566

(22) Filed: Oct. 23, 2024

Related U.S. Application Data
(63) Continuation of application No. PCT/CN2022/095239, filed on May 26, 2022.

(51) Int. Cl. B25J 9/16; B25J 9/04; B25J 13/08

(52) U.S. Cl. CPC B25J 9/1692; B25J 9/043; B25J 9/1641; B25J 13/088

(57) ABSTRACT

Embodiments of the present disclosure relate to a method and an apparatus for calibrating a thermal drift of a robot having at least one robot arms. The method includes detecting, in response to a reference point on the at least one robot arms being moved to a preselected position, an actual position of the reference point; calculating a deviation value between the preselected position and the actual position; and calibrating, based on the deviation value, a planned position or a planned path that the at least one robot arms are intended to move to or move along, to derive a calibrated position or a calibrated path.

### FIELD OF THE INVENTION

This invention relates to robots, and more particularly, to a method and an apparatus for calibrating a thermal drift of a robot having at least one robot arms.

### BACKGROUND OF THE INVENTION

In the machining industry, an influence of a thermal drift error on machining accuracy accounts for about 40%˜70% of the total error. Therefore, the accurate correction of the thermal error can significantly improve the positioning accuracy of a robot in a practical engineering application. Due to the complex and changeable environment of the customer application sites, the detection and optimization of the positioning accuracy simply pass a series of debugging in the factory. It may not be able to solve the problem of accuracy error encountered in a practical application on-site.

The expansion of material objects due to temperature change is generally referred to as “thermal expansion”. It usually means that when the external pressure remains unchanged, the volume of most substances increases when the temperature increases, and decreases when the temperature decreases.

There are many and complex reasons for the change of material object temperature. For example, the influence factors of the environment include room temperature, vibration, noise, radiation, etc. The robot's own influence factors include the change of equipment state or failure caused by long-time operation and high-speed operation.

### SUMMARY OF THE INVENTION

The invention is defined by the claims.

According to one aspect of the disclosure, there is provided a method for calibrating a thermal drift of a robot having at least one robot arms, the method comprising: detecting, in response to a reference point on the at least one robot arms being moved to a preselected position, an actual position of the reference point; calculating a deviation value between the preselected position and the actual position; and calibrating, based on the deviation value, a planned position or a planned path that the at least one robot arms are intended to move to or move along, to derive a calibrated position or a calibrated path.

With the method as provided, the calculation of the deviation value and the associated calibration can then be simplified, thereby improving the moving speed of the at least one arms of the robot and the processing speed.

In some embodiments, the at least one robot arms comprise a first robot arm and a second robot arm, each configured to rotatably connected to one another via a rotation axis and to be rotatable in an XY plane perpendicular to the rotation axis.

In some embodiments, said preselected position, said actual position, said planned position and said planned path each are at least measured by X and Y coordinates defined in the XY plane.

In some embodiments, the reference point is located at an end of the second robot arm distant from a joint between the first robot arm and the second robot arm.

In some embodiments, detecting the actual position of the reference point is performed by a detecting unit disposed at a distance from the at least one robot arms.

In some embodiments, calibrating the planned position or the planned path comprises: adding the deviation value to the planned position or the planned path.

In some embodiments, the method further comprises: rendering the at least one arms to move to the calibrated position or along the calibrated path.

In some embodiments, the preselected position is different from planned position or not comprised in the planned path.

In some embodiments, the method further comprises receiving an order that instructs the at least one robot arms to move to the planned position or the planned path, and the step of receiving the order is performed before or after the steps of detecting and calculating.

In some embodiments, the method further comprises: in the case that the at least one robot arms have finished the task arranged at the calibrated position or along the calibrated path, mandating the at least one robot arms to move the reference point back to the preselected position.

In some embodiments, the method further comprises: in the case that at least one robot arms are instructed to move along one same planned path for multiple times, mandating the at least one robot arms to move the reference point back to the preselected position after the at least one robot arms have completed for a predetermined number of times for the calibrated path.

In some embodiments, the robot is SCARA robot.

According to another aspect of the disclosure, there is provided an apparatus for calibrating a thermal drift of a robot having at least one robot arms, the apparatus comprising: a detecting unit for detecting, in response to a reference point on the at least one robot arms being moved to a preselected position, an actual position of the reference point; a calculating unit for calculating a deviation value between the preselected position and the actual position; and a calibrating unit for calibrating, based on the deviation value, a planned position or a planned path that the at least one robot arms are intended to move to or move along, to derive a calibrated position or a calibrated path.

According to yet another aspect of the disclosure, there is provided a robot system comprising: a robot having at least one robot arms; and a detecting unit for detecting, in response to a reference point on the at least one robot arms being moved to a preselected position, an actual position of the reference point; the robot comprises a processor configured to: calculate a deviation value between the preselected position and the actual position; and calibrate, based on the deviation value, a planned position or a planned path that the at least one robot arms are intended to move to or move along, to derive a calibrated position or a calibrated path.

According to yet another aspect of the disclosure, there is provided a machine readable storage medium having instructions stored thereon which, when executed by a processor, cause an apparatus to implement the method as described as above.

### BRIEF DESCRIPTION OF THE DRAWINGS

In the drawings, similar/same reference signs throughout different views generally represent similar/same parts. Drawings are not necessarily on scale. Rather, emphasis is placed upon the illustration of the principles of the present invention. In these drawings:

FIG. 1 illustrates an exemplary robot according to some embodiments of the present disclosure;

FIG. 2 illustrates a schematic depiction of the relationship between the arm length and the angular displacement of the first robot arm and the second robot arm of a SACRA robot in an XY coordinate system when there is no influence of the thermal shift;

FIG. 3 illustrates a schematic depiction of the relationship between the arm length and the angular displacement of the first robot arm and the second robot arm of a SACRA robot in an XY coordinate system when there is influence of the thermal shift;

FIG. 4 illustrates a schematic view of how planned positions different from the preselected position are calibrated;

FIG. 5 illustrates a flow chart of a method for calibrating a thermal drift of a robot having at least one robot arms in accordance with one aspect of the present disclosure;

FIG. 6 illustrates a schematic diagram of an apparatus for calibrating a thermal drift of a robot having at least one robot arms in accordance with another aspect of the present disclosure; and

FIG. 7 illustrates a schematic diagram of a robot system for calibrating a thermal drift of a robot having at least one robot arms in accordance with yet another aspect of the present disclosure.

### DETAILED DESCRIPTION OF THE EMBODIMENTS

Embodiments of the present disclosure will be described in more details with reference to the drawings. Although the drawings illustrate some embodiments of the present disclosure, it should be appreciated that the present disclosure can be implemented in various manners and should not be interpreted as being limited to the embodiments explained herein. On the contrary, the embodiments are provided to understand the present disclosure in a more thorough and complete way. It should be appreciated that drawings and embodiments of the present disclosure are only for exemplary purposes rather than restricting the protection scope of the present disclosure.

In the descriptions of the embodiments of the present disclosure, the term “include” and its variants are to be read as open-ended terms that mean “include, but is not limited to.” The term “based on” is to be read as “based at least in part on.” The terms “one embodiment” and “this embodiment” are to be read as “at least one embodiment.” The following text also can comprise other explicit and implicit definitions.

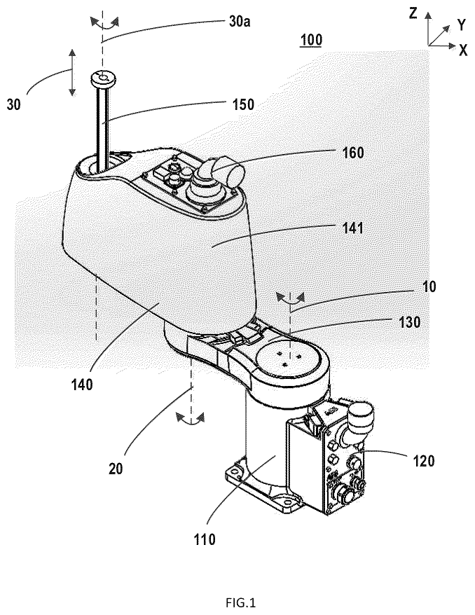

For the sake of description, FIG. 1 illustrates an exemplary robot 100 according to some embodiments of the present disclosure. Merely as an example, the robot 100 is shown as a Selective Compliance Assembly Robot Arm (SCARA) robot. As well known in the art, SCARA robot is a special type of industrial robot with multiple arms connected to each other. It generally has four degrees of freedom, including translation along X, Y and Z directions and rotation around Z axis.

As shown in FIG. 1, the SCARA robot 100 comprises as robot body parts a support 110, a robot console 120, a first robot arm 130, and a second robot arm 140. The robot console 120 may be mounted on a support 110 and held on it stationary. The support 110 can be fixed on a platform, e.g., a foundation or a movable vehicle.

The first robot arm 130 is rotatably mounted on the support 110 around a first rotation axis 10 and the second robot arm 140 is rotatably mounted on the first robot arm 130 around a second rotation axis 20. The first rotation axis 10 and the second rotation axis 20 are substantially parallel to one another. Further, the first robot arm 130 and the second robot arm 140 each extend in an XY plane, with the first rotation axis 10 and the second rotation axis 20 being substantially perpendicular to the XY plane.

Further, the second robot arm 140 may has a work unit 141. A connecting cable 160 may connect the robot console 120 and the second robot arm 140 for transmission of energy (current) and information therebetween. In some embodiments, an end effector (not shown) may be mounted at the end of the second robot arm 140 for operating or processing an object.

In some embodiments, a third robot arm 150 in the form of a spindle may be arranged passing through the work unit 141, with its longitudinal direction 30 substantially parallel to the first and second rotation axes 10 and 20. The third robot arm 150 is displaceable in its longitudinal direction, and is rotatable independently from it around its longitudinal axis 30a. In some embodiments, an end effector (not shown) may be mounted at the end of the third robot arm 150 for operating or processing an object.

The SCARA robot as discussed above has compliance in the X and Y directions and good stiffness in the Z direction. This characteristic is especially suitable for assembly work, such as inserting a round head needle into a round hole. For example, such a SCARA robot may be used to assemble printed circuit boards and electronic parts. Further, the SCARA robot has a two-bar structure connected in series, which is similar to a human arm. It is convenient for the robot arms to extend into a limited space for operation and then retract. Therefore, the SCARA robot is also suitable for moving and placing objects. With the above characteristic, the SCARA robot is widely used in the plastic industry, automobile industry, electronic product industry, pharmaceutical industry, food industry and so on.

During the movement of at least one robot arms of the robot, the positioning accuracy for the end effector is very important. However, as discussed in the Background, the thermal drift error has a great influence on the positioning accuracy. Taking into the various influence factors for temperature, to properly deal with the thermal drift might be challenging. For example, the overall deviation of positioning accuracy may come from the superposition effects brought by various influence factors for temperature. All these various and comprehensive factors will eventually affect the deviation of the end effector.

It is found that the traditional methods generally adopt a closed-loop real-time compensation. For example, when the end effector arrives at a working point, the deviation value is calculated by a vision camera, and then a calibrated working position is obtained based on the deviation value. These methods are quite common in the art, but there are also some shortcomings with these methods.

First, the vision camera tracks and calculates the working position of end effector in real time. This process will reduce the moving speed of the robot arms. For the processing application in the field of fast-moving consumer goods, it may not meet the on-site process requirements.

Second, the on-site working environment may have restrictions, which may not suitable for robots to carry out work with cameras.

To address the above shortcomings, the present disclosure proposes an improved concept for calibrating a thermal drift of a robot. Particularly, the robot is equipped with at least one robot arms. The concept may comprise: detecting, in response to a reference point on the at least one robot arms being moved to a preselected position, an actual position of the reference point; calibrating, based on the deviation value, a planned position or a planned path that the at least one robot arms are intended to move to or move along, to derive a calibrated position or a calibrated path. With the above concept, the deviation value due to the thermal drift can be calculated in a simpler manner, and can be used to compensate for the planned position or the planned path. Especially, the compensation can be performed before the robot starts to work, e.g., starts to move to the planned position or along planned path. In this way, there is no need to track and calculate the working position of the robot arms in real time, thereby improving the moving speed of the at least one arms and thus the processing speed.

For better understanding of the above concept, reference will be still made to a SCARA robot as disused above. However, it should be noted that the application of the above concept is not limited to a SCARA robot, but may be applied to any type of robots with at least one arms, as long as the at least one arms contribute to the thermal drift for affecting the positioning accuracy.

Herein, it is important to note that the above concept is established based on the inventor's following insight: For different application scenarios of the SCARA robot 100, the requirement for positioning accuracy on different directions might not be the same. For example, in some application scenarios, the requirement for positioning accuracy in an XY plane might be more rigorous or tougher as compared to that in the Z direction; while in some other application scenarios, the opposite might be required. Therefore, in some application scenarios, merely taking in account the positioning accuracy for merely some, rather than all, of the directions might be sufficient to meet the overall positioning accuracy requirements, and the positioning accuracy calculated for some particularly selected directions may represent the overall positioning accuracy.

Taking the SCARA robot 100 as an example, the requirement for the positioning accuracy of the three robot arms 130, 140 and 150 in the XY plane might be more rigorous or tougher than in the Z direction and considering the fact that the third arm 150 merely extends and moves along the Z direction, the positioning accuracy in the XY plane may represent the overall positioning accuracy of the whole robot. Herein the influence of the third arm 150 on the positioning accuracy in the XY plane may be omitted.

As such, the present disclosure proposes a simplified method for compensating the thermal shift. In the case of a SACRA robot, the positioning accuracy for the at least one robot arms can thus be simplified as equivalent to the positioning accuracy in the XY plane, which, in turn, can be calculated based on the relationship between the arm length and the angular displacement of the first robot arm and the second robot arm.

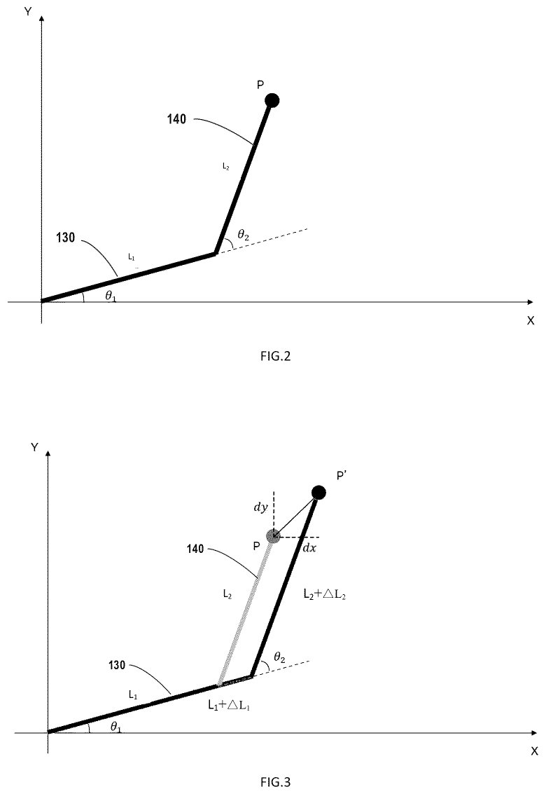

FIG. 2 illustrates a schematic depiction of the relationship between the arm length and the angular displacement of the first robot arm and the second robot arm of a SACRA robot in a XY coordinate system when there is no influence of the thermal shift; while FIG. 3 illustrates a schematic depiction of the relationship between the arm length and the angular displacement of the first robot arm and the second robot arm of a SACRA robot in a XY coordinate system when there is influence of the thermal shift. For simplicity, in FIGS. 2 and 3 the origin of the coordinate system is defined at a joint between the first robot arm 130 and the support 110, the first robot arm 130 and the second robot arm 140 are represented by line segments, and the third arm 150 is omitted.

As shown in FIGS. 2 and 3, the length of the first robot arm 130 and the second robot arm 140 of a SACRA robot each may be further denoted by L₁ and L₂, respectively, and the angular displacement of the first robot arm 130 and the second robot arm 140 each may be denoted by θ₁ and θ₂, respectively.

Let's assume that there is no thermal shift in FIG. 2, the position of the end effector or an end of the second robot arm 140 distant from the first robot arm can then be expressed as below:

$$P ( x , y ) = F ( {L}_{1} , {θ}_{1} , {L}_{2} , {θ}_{2} ) \qquad ( 1 )$$

And if there is thermal shift in FIG. 3, the position of the end effector or an end of the second robot arm 140 distant from the first robot arm can then be expressed as below:

$$P ’ ( x + dx , y + d y ) = F ( {L}_{1} + Δ {L}_{1} , {θ}_{1} , {L}_{2} + Δ {L}_{2} , {θ}_{2} ) \qquad ( 2 )$$

By comparison of equation (1) and (2), it will be understood that “ΔL₁” accounts for the thermal drift for the first robot arm 130, “ΔL₂” accounts for for the thermal drift for the second robot arm 140, “dx” accouts for the thermal drift for the whole robot arms in the X direction, and “dy” accouts for the thermal drift for the whole robot arms in the Y direction. If parameters P, P′, L₁, L₂ are known, deviation values such as (ΔL₁, ΔL₂) or (dx, dy) can then be calculated and are able to be used for compensating the thermal shift that presents in any other position in the XY plane.

Following the above analysis, it can be further derived that if deviation values in the XY plane, e.g., (ΔL₁, ΔL₂) or (dx, dy), of a reference point on the at least one arms can be determined, then all the planned positions or planned path of the reference point in the XY plane can be calibrated based on the deviation value. Such a calibration may be performed prior to the robot starting to move the at least one arms to the planned position or along the planned path, wherein the planned position may be different from the preselected postion, and may or may not comprised in the planned path.

According to the present disclosure, the reference point may be any point on the at least one arms, as long as the reference point can reflect the trajectory of the end effector. In one preferred example, the reference point may be a selected point on the end effector. In another preferred example, the reference point may be a joint between the second arm 140 and the third arm 150. In yet another preferred example, the reference point may be an end of the second arm 140 that is distant from a joint between the second arm 140 and the first arm 130.

According to the present disclosure, a preselected position in the XY plane may be used to calculate the deviation values of the reference point on the at least one arms. Herein by term “a preselected position” it means a theoretical position, e.g., an instructed (e.g., by a processor) and yet-to-be calibrated position, that the robot arms are instructed to move the reference point to in e.g., the XY plane. It is appreciated that any position in the XY plane may be preselected as the preselected position. In some embodiments, the preselected position may be pre-selected to be near the support 110 of the robot in the XY plane. In some embodiments, the preselected position may be pre-selected to be the center of the planned path that the at least one arms are intended to move along. Sometimes, the preselected position may be referred to as “a home position”. As an example, a preselected position may pre-designated at X=1, Y=2 in the XY plane.

The actual position of the reference point in the XY plane may be detected by a detecting unit, e.g., a camera. It is understood that due to the thermal shift, the XY coordinates of the preselected position may be actually shifted to X=1.1 and Y=2.2, as compared to the original coordinates X=1 and Y=2. In accordance with the actual position of the reference point and the preselected position, the deviation values in the XY plane, e.g., (ΔL₁, ΔL₂) or (dx, dy), can then be easily derived.

In some embodiments, the detecting unit may be disposed on an entity that is separate from the robot 100. In one preferred example, the detecting unit may be disposed on a platform where the robot also stands. In another preferred example, the detecting unit may be disposed beneath the at least one robot arms. In this way, the actual position of the reference point on the at least one arms can be easily detected.

It is noted that although in the above description the detecting unit arranged on a different entity the robot may be preferred, in some embodiments other positions for the detecting unit is also possible. For example, it is possible to arrange the detecting unit on the robot itself, e.g., on the support 110, or the at least one robot arms, as long as the detecting unit can detect the actual position of the reference point in the XY plane.

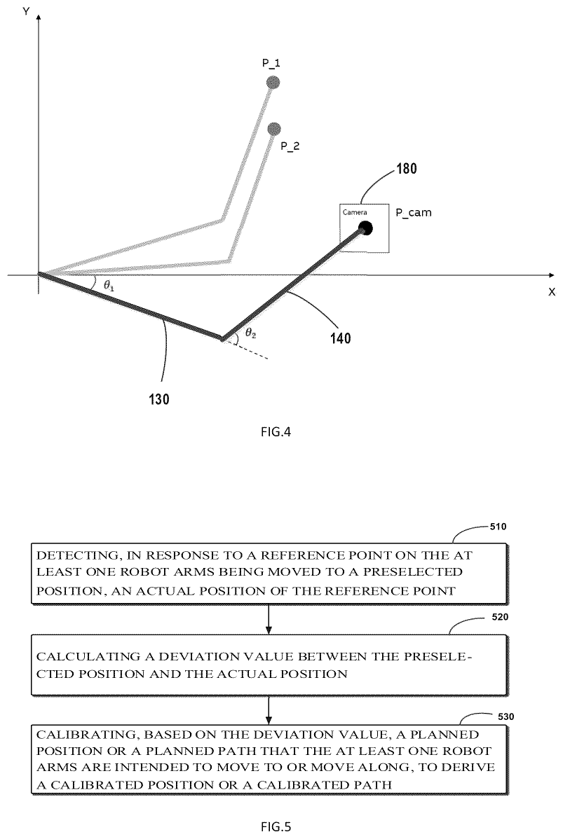

For better understanding of the calibration method, FIG. 4 shows a schematic view of how other planned positions different from the preselected position are calibrated.

In FIG. 4, P_cam denotes a preselected position, and P_1 and P_2 each denote a planned position that the at least one robot arms are intended to move to, respectively. As an example, a detecting unit 180 may be placed on a platform beneath the at least one robot arms.

Prior to moving the at least one robot arms to the planned position, e.g., P_1 or P_2, the reference point on the at least one robot arms may be firstly instructed to move to the preselected position P_cam. In response to the reference point being moved to P_cam, the detecting unit 180 may detect the actual position of the reference point in the XY plane. According, a deviation value between the preselected position P_cam and the actual position can be calculated. Once the deviation value is calculated, other planned positions including e.g., P_1 and P_2, different from the preselected position can be calibrated based on the deviation value, so as to derive a calibrated positon. Without doubt, this calibration procedure can also be applied to a planned path that the at least one robot arms are intended to move along, which planned path actually represents a succession of planned positions.

It is understood that with the above calibration procedure, the planned position or planned path can be more efficiently calibrated, as compared to the existing compensation method. Especially, the planned position or planned path can be calibrated prior to the at least robot arms actually starting to move. That is, there is no need in the present calibration procedure to calibrate working position of the at least one arms in real time, which can greatly improve the moving speed of the at least one robot arms.

FIG. 5 is a flow chart of a method for calibrating a thermal drift of a robot having at least one robot arms according to one aspect of the present disclosure.

In some embodiments, the robot may be a SACRA robot, which generally has three arms. However, in other embodiments, the robot may be any other type of robot having at least one robot arms, as long as the at least one robot arms may be affected by the thermal drift. For instance, in one example, the robot may be a type of robot having a first robot arm and a second robot arm, each configured to rotatably connected to one another via a rotation axis and to be rotatable in an XY plane perpendicular to the rotation axis, and an end effector may be fixed to the end of the second robot arm. In another example, the robot may be a type of robot having merely one robot arm extending in the XY plane, and an end effector may be fixed to the end of the second robot arm.

It is appreciated that the thermal drift may result from various influence factors including room temperature, vibration, noise, radiation, the change of equipment state or failure caused by long-time operation and high-speed operation, etc.

The method comprises at block 510, detecting, in response to a reference point on the at least one robot arms being moved to a preselected position, an actual position of the reference point.

In some embodiments, the reference point may represent an end effector fixed on the at least one arms. In some embodiments, the reference point may represent a joint between the second arm and the third arm. In some embodiments, the reference point may represent an end of the second arm that is distant from a joint between the first arm and the second arm. Generally, the present disclosure does not limit the positon of the reference point on the at least one arms, as long as the reference point may be used to reflect the trajectory of an end effector.

A detecting unit, e.g., a camera, may be used to detect the actual position of the reference point. In some embodiments, the detecting unit may be disposed at a distance from the at least one robot arms. For example, the detecting unit may be arranged on a same platform where the robot stands. In some embodiments, the detecting unit may be disposed on the robot itself, e.g., on the support of the SCARA robot, or any stationary position on the robot.

It should be understood that as compared to the actual positon, the preselected position is a theoretical position, e.g., an instructed (e.g., by a processor) and yet-to-be calibrated position, that the robot arms are instructed to move the reference point to in e.g., the XY plane. According to the present disclosure, the preselected position may be different from the planned positon that the at least one robot arms are intended to move, or may or may not be comprised by the planned path that the at least one robot arms are intended to move along.

Once the actual positon is detected, then at block 520, calculating a deviation value between the preselected position and the actual position.

In accordance with the present disclosure, said preselected position, said actual position, said planned position and said planned path could be measured only by X and Y coordinates defined in the XY plane. In this way, the calculation of the deviation value between the preselected position and the actual position may be simplified.

Generally, when calculating the deviation value between the preselected position and the actual position, taking into account some of the at least one robot arms that contribute most to the thermal shift might be sufficient to meet the positioning accuracy requirement in some application scenarios. For example, in the case of a SCARA robot, when calculating the deviation value between the preselected position and the actual position, it is possible to merely consider the influence on the first arm and the second arm by the thermal effect, and the influence of the third robot arm may be omitted. In this way, the calculating method for the deviation value can be simplified and the calculating speed can be improved, as compared to the existing calculating methods.

The method comprises at block 530, calibrating, based on the deviation value, a planned position or a planned path that the at least one robot arms are intended to move to or move along, to derive a calibrated position or a calibrated path.

In some embodiment, the calibrating can be performed by simply combining the deviation value with the planned position or the planned path, e.g., adding the deviation value to the planned position or the planned path. In some other embodiments, the deviation value may be further calibrated, e.g., by multiplying a weighting factor which may depend on the gesture of the at least one arms or the working environment of the at least one arms. In this way, the planned position or the planned path may be calibrated with higher accuracy.

In addition to the above steps, in some embodiments, the method may further comprises receiving an order that instructs the at least one robot arms to move to the planned position or the planned path. In one example, the order may be input by a user. In another example, the order may be input during the manufacturing of the robot. Further, the step of receiving the order may be performed before or after the steps of detecting and calculating.

In some embodiments, the method may further comprise: rendering the at least one arms to move to the calibrated position or along the calibrated path. Generally, a corresponding task may be arranged on the calibrated position or along the calibrated path. In one example, the task may be inserting a round head needle into a round hole at the calibrated position. In another example, the task may be drawing a circle while moving along the calibrated path.

In some embodiments, the method may further comprise: in the case that the at least one robot arms have finished the task arranged at the calibrated position or along the calibrated path, mandating the at least one robot arms to move the reference point back to the preselected position. In this way, the planned position or the planned path can always be calibrated before a next task.

In some embodiments, the method may further comprise: in the case that at least one robot arms are instructed to move along one same planned path for multiple times, mandating the at least one robot arms to move the reference point back to the preselected position after the at least one robot arms have moved for a predetermined number of times for the calibrated path. For example, a predetermined number of times may be any selected times, e.g., 1, 2, 3. In this way, the planned path can be calibrated every once in a while, keeping the planned path calibrated with time and meanwhile without tracking the actual position of the robot arms in real time.

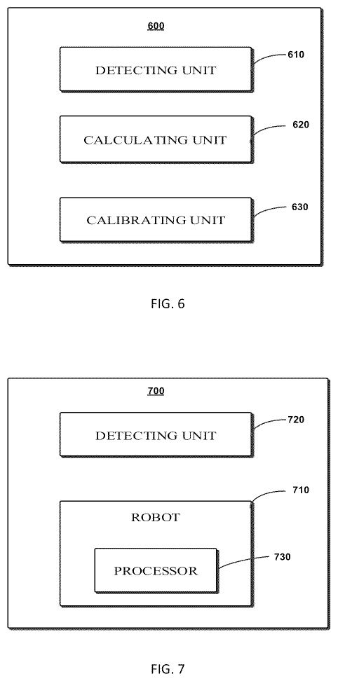

Besides the above method, in accordance with another aspect of the present disclosure, there is also provided an apparatus 600 for calibrating a thermal drift of a robot having at least one robot arms. FIG. 6 illustrates a schematic diagram of such an apparatus 600.

Referring to FIG. 6, the apparatus 600 may comprises a detecting unit 610, a calculating unit 620 and a calibrating unit 630. In some embodiments, the apparatus may be a part of a robot or integrated in a robot. In some embodiments, the apparatus may be separate from the robot.

The detecting unit 610 is configured for detecting, in response to a reference point on the at least one robot arms being moved to a preselected position, an actual position of the reference point. As an example, a detecting unit 610 may be a camera. In some embodiments, the detecting unit 610 may be placed on a platform where the robot also stands. In some embodiments, the detecting unit 610 may be positioned right beneath the at least one arms. In some embodiments, the detecting unit 610 may probably be positioned on the robot itself, e.g., on the support of the robot.

Generally, the reference point may be any point on the at least one arms, as long as the reference point can reflect the trajectory of the end effector. In some embodiments, the reference point may be a selected point on the end effector fixed on the at least one arms. In some embodiments, the reference point may be a joint between the second arm 140 and the third arm 150. In yet another preferred example, the reference point may be an end of the second arm 140 that is distant from a joint between the second arm 140 and the first arm 130. In any way, the reference point should be preselected such that the detecting unit can detect the actual position of the reference point.

In accordance with the present disclosure, the preselected position is a theoretical position, e.g., an instructed and yet-to-be calibrated position, that the robot arms are instructed to move the reference point to in e.g., the XY plane. Generally, the actual position of a reference point would deviate from the preselected position due to the thermal shift.

The calculating unit 620 is configured for calculating a deviation value between the preselected position and the actual position.

In some embodiments, the preselected position and the actual position could be measured only by X and Y coordinates defined in the XY plane. In this way, the calculation of the deviation value can be simplified. This is because in some applications, merely taking into account some of the at least one robot arms, e.g., the first and second robot arms that extend in the XY plane, might be sufficient to meet the positioning accuracy requirement in some application scenarios.

The calibrating unit 630 is configured for calibrating, based on the deviation value, a planned position or a planned path that the at least one robot arms are intended to move to or move along, to derive a calibrated position or a calibrated path.

In some embodiment, the calibrating can be performed by simply combining the deviation value with the planned position or the planned path, e.g., adding the deviation value to the planned position or the planned path. In some other embodiments, the deviation value may be further calibrated.

Besides the above functional units, the apparatus 600 may further comprise other functional units, e.g., a receiving unit configured for receiving an order that instructs the at least one robot arms to move to the planned position or the planned path. In one example, the order may be input by a user. In another example, the order may be input during the manufacturing of the robot. In practice, the step of receiving the order may be performed before or after the steps of detecting and calculating.

The apparatus 600 may further comprise an actuating unit configured for rendering the at least one arms to move to the calibrated position or along the calibrated path. Generally, a corresponding task may be arranged on the calibrated position or along the calibrated path.

In some embodiments, the actuating unit may be further configured for: in the case that the at least one robot arms have finished the task arranged at the calibrated position or along the calibrated path, mandating the at least one robot arms to move the reference point back to the preselected position. In this way, the planned position or the planned path can always be calibrated before a next task.

In some embodiments, the actuating unit may be further configured for: in the case that at least one robot arms are instructed to move along one same planned path for multiple times, mandating the at least one robot arms to move the reference point back to the preselected position after the at least one robot arms have moved for a predetermined number of times for the calibrated path. In this way, the planned path can be calibrated every once in a while, keeping the planned path calibrated with time and meanwhile without tracking the actual position of the robot arms in real time.

In accordance with yet another aspect of the present disclosure, there is provided a robot system 700 for calibrating a thermal drift of a robot having at least one robot arms. FIG. 7 illustrates a schematic diagram of such a robot system 700.

As shown in FIG. 7, the robot system 700 may comprises a robot 710 having at least one robot arms and a detecting unit 720 coupled to the robot 700.

In some embodiments, the robot 710 may be a SACRA robot, which generally has three arms. In some other embodiments, the robot may be any other type of robot having at least one robot arms, as long as the at least one robot arms may be affected by the thermal drift. Particularly, in one example, the robot may be a type of robot having a first robot arm and a second robot arm, each configured to rotatably connected to one another via a rotation axis and to be rotatable in an XY plane perpendicular to the rotation axis, and an end effector may be fixed to the end of the second robot arm. In another example, the robot may be a type of robot having merely one robot arm extending in the XY plane, and an end effector may be fixed to the end of the second robot arm.

The detecting unit 720 is configured for detecting, in response to a reference point on the at least one robot arms being moved to a preselected position, an actual position of the reference point.

In some embodiments, the reference point may represent an end effector fixed on the at least one arms. In some embodiments, the reference point may represent a joint between the third arm and the second arm. In some embodiments, the reference point may represent an end of the second arm that is distant from the joint between the first arm and the second arm. Generally, the present disclosure does not limit the positon of the reference point on the at least one arms, as long as the reference point can be used to reflect the trajectory of end effector.

In some embodiments, the detecting unit 720 may be a camera or any other sensor that may be used to detect the actual position of the reference point. In one example, the detecting unit 720 may be disposed at a distance from the robot 710, e.g., at a distance from the at least one robot arms. In another example, the detecting unit may be arranged on a same platform where the robot also stands. In yet another example, the detecting unit may be disposed on the robot itself, e.g., on the support of the SCARA robot, or any stationary position on the robot.

Once the actual position is detected, the detection result could be transmitted to the robot 710, via a wired or wireless connection.

The robot 710 may further comprise a processor 730 configured to calculate a deviation value between the preselected position and the actual position; and calibrate, based on the deviation value, a planned position or a planned path that the at least one robot arms are intended to move to or move along, to derive a calibrated position or a calibrated path.

In some embodiments, said preselected position, said actual position, said planned position and said planned path could be measured only by X and Y coordinates defined in the XY plane. In this way, the calculation of the deviation value between the preselected position and the actual position may be simplified.

As stated above, taking into account some of the at least one robot arms that contributes most to the thermal shift might be sufficient to meet the positioning accuracy requirements in some application scenarios. Particularly, in the case of a SCARA robot, when calculating the deviation value between the preselected position and the actual position, it is possible to merely consider the influence of the thermal effect on the first arm and the second arm, and the influence of the thermal effect on the third robot arm may be omitted. In this way, the calculating method for the deviation value can be simplified and the calculating speed can be improved, as compared to the existing calculating methods.

In some embodiments, the calibrating can be performed by simply combining the deviation value with the planned position or the planned path, e.g., adding the deviation value to the planned position or the planned path.

In some embodiments, the processor may be further configured to receive an order that instructs the at least one robot arms to move to the planned position or the planned path. In one example, the order may be input by a user. In another example, the order may be input during the manufacturing of the robot. Particularly, the step of receiving the order may be performed before or after the steps of detecting and calculating.

In some embodiments, the processor may be further configured to cause an actuation unit to render the at least one arms to move to the calibrated position or along the calibrated path. Generally, a corresponding task may be arranged on the calibrated position or along the calibrated path. In one example, the task may be inserting a round head needle into a round hole at the calibrated position. In another example, the task may be drawing a circle along the calibrated path.

In some embodiments, the processor may be further configured to: in the case that the at least one robot arms have finished the task arranged at the calibrated position or along the calibrated path, cause an actuation unit to mandate the at least one robot arms to move the reference point back to the preselected position. In this way, the planned position or the planned path can always be calibrated before a next task.

In some embodiments, the processor may be further configured to: in the case that at least one robot arms are instructed to move along one same planned path for multiple times, cause an actuation unit to mandate the at least one robot arms to move the reference point back to the preselected position after the at least one robot arms have travelled for a predetermined number of times for the calibrated path. In this way, the planned path can be calibrated every once in a while, keeping the planned path calibrated with time and meanwhile without tracking the actual position of the robot arms in real time.

In accordance with yet another aspect of the present disclosure, there is provided a machine readable storage medium having instructions stored thereon which, when executed by a processor, cause an apparatus or a robot or a robot system to implement the method as described above.

In some embodiments, the machine readable storage medium may include but not be limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Various implementations of the present disclosure have been described in detail above. It should be noted that these various implementations of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof

In addition, although the above method is described with steps in sequence. The order of the steps in the method may be changed, reordered, combined, omitted, modified, etc., as appropriate for different application scenarios. In addition, functions in different modules or blocks in a block diagram can be integrated in one same module or block, or a function in one module or block can be implemented in two or more discrete modules or blocks.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A method for calibrating a thermal drift of a robot having at least one robot arms, the method comprising:
detecting, in response to a reference point on the at least one robot arms being moved to a preselected position, an actual position of the reference point;
calculating a deviation value between the preselected position and the actual position; and
calibrating, based on the deviation value, a planned position or a planned path that the at least one robot arms are intended to move to or move along, to derive a calibrated position or a calibrated path.

2. The method of claim 1, wherein the at least one robot arms comprise a first robot arm and a second robot arm, each configured to rotatably connected to one another via a rotation axis and to be rotatable in an XY plane perpendicular to the rotation axis.

3. The method of claim 2, wherein said preselected position, said actual position, said planned position and said planned path each are at least measured by X and Y coordinates defined in the XY plane.

4. The method of claim 2, wherein the reference point is located at an end of the second robot arm distant from a joint between the first robot arm and the second robot arm.

5. The method of claim 1, wherein detecting the actual position of the reference point is performed by a detecting unit disposed at a distance from the at least one robot arms.

6. The method of claim 1, wherein calibrating the planned position or the planned path comprises:
adding the deviation value to the planned position or the planned path.

7. The method of claim 1, further comprising:
rendering the at least one arms to move to the calibrated position or along the calibrated path.

8. The method of claim 1, wherein the preselected position is different from planned position or not comprised in the planned path.

9. The method of claim 1, further comprising receiving an order that instructs the at least one robot arms to move to the planned position or the planned path, and the step of receiving the order is performed before or after the steps of detecting and calculating.

10. The method of claim 1, further comprising:
in the case that the at least one robot arms have finished the task arranged at the calibrated position or along the calibrated path, mandating the at least one robot arms to move the reference point back to the preselected position.

11. The method of claim 1, further comprising:
in the case that at least one robot arms are instructed to move along one same planned path for multiple times, mandating the at least one robot arms to move the reference point back to the preselected position after the at least one robot arms have completed for a predetermined number of times for the calibrated path.

12. The method of claim 1, wherein the robot is SCARA robot.

13. An apparatus for calibrating a thermal drift of a robot having at least one robot arms, the apparatus comprising:
a detecting unit for detecting, in response to a reference point on the at least one robot arms being moved to a preselected position, an actual position of the reference point;
a calculating unit for calculating a deviation value between the preselected position and the actual position; and
a calibrating unit for calibrating, based on the deviation value, a planned position or a planned path that the at least one robot arms are intended to move to or move along, to derive a calibrated position or a calibrated path.

14. A robot system comprising:
a robot having at least one robot arms; and
a detecting unit for detecting, in response to a reference point on the at least one robot arms being moved to a preselected position, an actual position of the reference point;
the robot comprises a processor configured to:
calculate a deviation value between the preselected position and the actual position; and
calibrate, based on the deviation value, a planned position or a planned path that the at least one robot arms are intended to move to or move along, to derive a calibrated position or a calibrated path.

15. A machine readable storage medium having instructions stored thereon which, when executed by a processor, cause an apparatus to implement the method of claim 1.
